(19) United States
(12) Patent Application Publication
(10) Pub. No.: US 2022/0406116 A1
(43) Pub. Date: Dec. 22, 2022

(54) BALLOT DOCUMENT SYSTEM AND METHODS THEREOF

(71) Applicant: Runbeck Election Services Inc., Phoenix, AZ (US)

(72) Inventors: Bryan Dandurand, Phoenix, AZ (US); Jeff Ellington, Phoenix, AZ (US)

(21) Appl. No.: 17/845,840

(22) Filed: Jun. 21, 2022

Related U.S. Application Data
(60) Provisional application No. 63/212,504, filed on Jun. 18, 2021.

(51) Int. Cl. G07C 13/00; G06K 7/12

(52) U.S. Cl. CPC G07C 13/00; G06K 7/12; G06Q 2230/00

(57) ABSTRACT

Various embodiments of a paper article defining a verifiable elections document including multiple verification elements and associated systems and methods are disclosed.

### CROSS REFERENCE TO RELATED APPLICATIONS

The present application claims benefit to U.S. Provisional Patent Application Ser. No. 63/212,504 filed on Jun. 18, 2022 which is hereby incorporated by reference in its entirety.

### FIELD

The present disclosure generally relates to systems and products associated with elections services; and in particular, to an enhanced paper article defining an elections document and including one or more elements for verification and methods and systems thereof.

### BACKGROUND

Voter registration and processing of elections-related documents demands efficiency but is constrained by (important) accuracy thresholds and error minimization requirements. State and local elections officials continue to desire technical improvements to deliver timely elections services and efficiently manage day-to-day elections activities. In particular, verification and security associated with elections documents is paramount.

It is with these observations in mind, among others, that various aspects of the present disclosure were conceived and developed.

### SUMMARY

The following presents a simplified summary of various aspects described herein. This summary is not an extensive overview and is not intended to identify key or critical elements or to delineate the scope of the claims. The following summary merely presents some concepts in a simplified form as an introductory prelude to the more detailed description below. Corresponding apparatus, systems, and computer-readable media examples are also within the scope of the disclosure.

Aspects of the disclosed inventive concept may take the form of a paper article enhanced for elections security and verification. The paper article includes a paper body including a predetermined elections document configuration and defining an elections document. The paper article further includes a plurality of verification elements that accommodate verification of the elections document. The plurality of verification elements is tailored according to the predetermined elections document configuration to satisfy rules for elections processing. The plurality of verification elements includes, by non-limiting examples, an infrared (IR) tangent, a ultraviolet (UV) light marker, a micro-text, a file identifier, and/or a machine-readable identifier such as a bar code or RFID. The plurality of verification elements is verifiable or otherwise accessible or interpreted by one or more verification devices such as a camera, a UV light detector, and/or an IR device.

Aspects of the inventive concept may take the form of a method of making a paper article, comprising the steps of forming, by a paper manufacturing device, a paper article with a first verification element based on a predetermined elections document configuration; and applying, via a printing device, a print job to the paper article such that the paper article includes a second verification element based on the predetermined elections document configuration, wherein each of the first verification and the second verification element is verifiable by one or more verification devices. The method may further include the steps of accessing, via a processor, elections data defining rules associated with a state election; and selecting the predetermined elections document configuration for manufacturing the paper article based upon the rules associated with the state election. The method may further include the steps of issuing an instruction from the processor to the paper manufacturing device to form the paper article with the first verification element based on the predetermined elections document configuration as selected; and issuing an instruction from the processor to apply a print job to the paper article such that the paper article includes a second verification element based on the predetermined elections document configuration as selected.

Aspects of the present inventive concept may take the form of a system for manufacturing paper articles as elections documents with enhanced verification and security measures, comprising: a paper manufacturing device that forms a paper article defining an elections document with a first verification element; and a printing device that receives the paper upon being formed from the paper manufacturing device and prints a second verification element along the paper article, wherein each of the first verification and the second verification element is verifiable by one or more verification devices.

These examples and features, along with many others, are discussed in greater detail below.

### BRIEF DESCRIPTION OF THE DRAWINGS

FIG. 1 is a simplified block diagram of an example system for manufacturing an elections document with multiple verification elements.

FIG. 2 is a simplified illustration of an exemplary elections document created from the system of FIG. 1; the elections document including multiple verification elements.

FIG. 3 is a simplified block diagram illustrating an exemplary process flow for generating the exemplary elections document of FIG. 2.

FIG. 4 is a simplified block diagram illustrating an exemplary process flow associated with FIGS. 1-2.

FIGS. 5A-5C are simplified illustrations of non-limiting example elections documents with various combinations of verification elements.

FIG. 6 is a simplified schematic diagram illustrating an exemplary computing device that may be configured to implement various functions and methods described herein.

Corresponding reference characters indicate corresponding elements among the view of the drawings. The headings used in the figures do not limit the scope of the claims.

### DETAILED DESCRIPTION

Aspects of the present disclosure relate to embodiments of a paper article defining an elections document enhanced with verification and security features for elections processing. In some examples, the paper article is formed using a system and includes multiple verification elements which may be confirmed or identified by one or more devices so that the elections document can be authenticated, satisfy security checks and/or security parameters, and the like. In general, the verification elements are pre-selected or otherwise defined by a predetermined elections document configuration associated with the elections document. The verification elements may be integrated to within or along the elections document during manufacturing (or thereafter), and may include, by non-limiting examples, an infrared (IR) tangent or IR component readable by an IR scanner, ultraviolet (UV) light detectable pattern or identifier, a unique watermark, micro-text, machine-readable identifier (e.g., barcode), and/or a unique file number and/or combinations thereof. So, for example, the IR tangent of the elections document can be read by the IR scanner to verify that the elections document is valid, authenticated, or is otherwise linked to a specific source manufacturer or device for any verification purpose. In some embodiments, two or more of the verification elements may be combined to further enhance verification benefits. For example, a first verification element in the form of a watermark may be positioned along the document overlapping a second verification element in the form of a UV identifier, and each of the subject first and second verification elements can be identified or otherwise authenticated at the same time, reducing verification time and increasing efficiency during elections processing. One or more devices may be used to identify any of the verification elements as described herein. Accordingly, the elections document, (also referred to herein as “Ballot Guard”) is part of an improved system for securing elections, as the document accommodates verification in multiple ways.

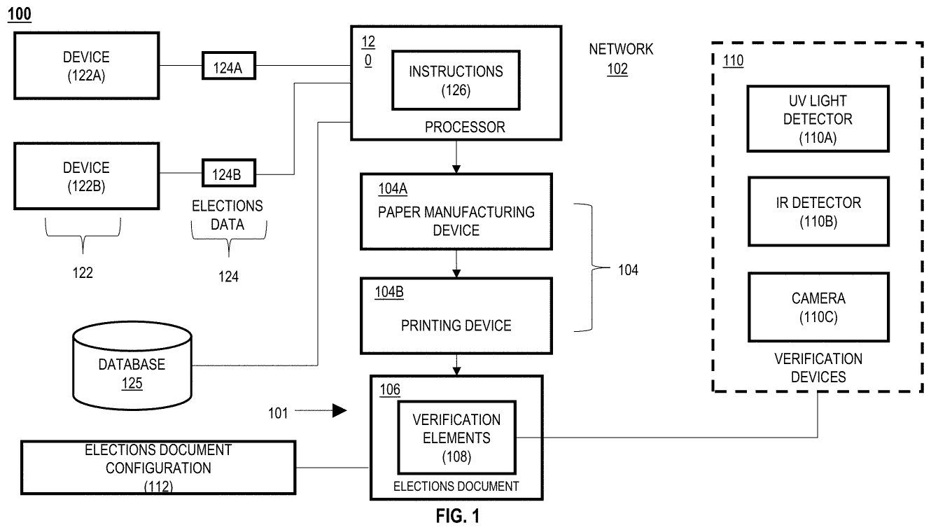

Referring to FIG. 1, any of the aforementioned embodiments of a system for generating the elections document described herein may take the form of a computer-implemented system, designated system 100, supported by a network 102 of exemplary devices and components for forming a paper article 101 enhanced for elections security. In general, the system 100 includes a plurality of document manufacturing devices 104; including, by non-limiting examples, at least one of a paper manufacturing device 104A and at least one printing device 1046. Document manufacturing devices 104 include any number or type of device suitable for forming the paper article 101 to be enhanced as described in mass quantities for elections use and processing. As further indicated, the paper article 101 may define an elections document 106 such as a ballot. Regardless, the paper article 101 is formed with one or more verification elements 108 that facilitate verification, authentication, and/or identification of one or more of the elections documents 106 during elections processing. The verification elements 108 may include by non-limiting examples, any number or combination of a watermark, a machine-readable identifier, a UV light marker, an IR tangent, micro-text, and/or a file identifier, as further described herein. In addition, the verification elements 108 may be identified, interpreted, used to verify the elections document 106, or otherwise accessed by one or more verification devices 110, as further described herein.

In some embodiments, the paper manufacturing device 104A includes any such manufacturing device or paper machine (e.g., Fourdrinier-type machine) for creating one or more of the paper articles 101 industrially in large quantities. In general, as would be understood by one of ordinary skill in the art, paper production involves a preparing moving woven mesh to create a continuous paper web by filtering out fibres held in a paper stock and producing a continuously moving web mat of fibre. The fibre is further dried to produce a firmer paper web. Paper production by the paper manufacturing device 104A may further include discrete operation sections including forming, pressing, drying, a size press section, calendar section, and a reel section. The paper sheets ultimately created can further be compressed, coated, or impregnated with one or more components (e.g., IR tangents, or other verification elements 108). Further, various materials may be introduced into the paper stock, and treatments may be applied during formation. One or more of the verification elements 108 may be introduced by the paper manufacturing device 104A or otherwise introduced during formation of the article 101, as further described herein.

The printing device 1046 receives paper formed by the paper manufacturing device 104A and prints the elections document 106 or otherwise applies a print job to the paper article 101 according to any desired specifications. The printing device 104B may be configured to print any elections documents using the paper from the paper manufacturing device 104A such as ballots or other similar elections documents. In some embodiments, the printing device 104B may comprise, by non-limiting examples, any industrial printing device such a OKI version b432, c532, c831, c931, or c9650, or a Lexmark version c4150 or cs923 and the like. Similar to the paper manufacturing device 104A, one or more of the verification elements 108 may be introduced by the printing device 104B for the elections document 106, as further described herein.

As further shown in FIG. 1, the elections document 106 may be formed within any combination or type of the verification elements 108 as defined by a predetermined elections document configuration 112. The elections document configuration 112 includes a template, mapping, or any data structure that delineates where and which of the verification elements 108 are implemented with the elections document 106. For instance, one example of an elections document configuration 112 may be used to form an elections document 106 with a first verification element in the upper right-hand corner of a front side of the elections document, and a second verification element in the lower left of the front side. The elections document configuration 112 may be referenced or leveraged by the document manufacturing devices 104 to tailor the elections document 106 accordingly. In some embodiments, the elections document configuration 112 can be dictated or otherwise generated based on specifications and/or rules of a state election, and may be applied using a processor, as further described herein.

In some examples, the system 100 includes a processor 120 in communication with a plurality of devices 122, designated by example as device 122A and device 122B. Devices 122 include any computing device or similar hardware device capable of transmitting, hosting, or accessing elections data 124 which may define any information about a particular election and/or jurisdiction including various parameters associated with the election. By non-limiting examples, the devices 122 include mobile devices such as laptops, tablets, smartphones and the like, and also any computing device, server, or similar hardware component that can receive/access and transmit elections data 124 to the processor 120. The processor 120 is further in operable communication with one or more of a database 125 stored in some memory or storage device. The processor 120 access the elections data 124 from the devices 122 and the elections data 124 is organized and stored in the database 125 to configure an elections document 106 such as a ballot, as further described herein.

In some embodiments, the document manufacturing devices 104 are configured to function cooperatively with the processor 120 to manufacture and print the elections document 106, according to configurations and parameters defined by the elections data 124. In particular, the document manufacturing devices 104, based upon instructions or commands from the processor 120, cooperatively create the elections document 106 with the plurality of verification elements 108 according to any predetermined elections document configuration 112 so as to improve election document verification, as further described herein.

In these embodiments, the processor 120 is in operable communication with the plurality of document manufacturing devices 104; including, by non-limiting examples, the paper manufacturing device 104A and the printing device 104B. Document manufacturing devices 104 include any number of type of device suitable for functioning cooperatively with the processor 120 to manufacture and print the elections document 106, according to configurations and parameters defined by the elections data 124, the predetermined elections document configuration 112, or otherwise.

As indicated, the processor 120 accesses and executes instructions 126 that configure the processor 120 to execute commands to other devices (such as the document manufacturing devices 104) and otherwise perform operations for forming the elections document 106 with the verification elements 108 as described. The processor 120 may be implemented via one or more computing devices, and may include any number of suitable processing elements. The instructions 126 may further define or be embodied as code and/or machine-executable instructions executable by the processor 120 that may represent one or more of a procedure, a function, a subprogram, a program, a routine, a subroutine, a module, an object, a software package, a class, or any combination of instructions, data structures, or program statements, and the like. In other words, aspects of the elections-document formation and verification element functionality described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) of the instructions 126 may be stored in a computer-readable or machine-readable medium (e.g., main memory 1204), and the processor 120 performs the tasks defined by the code. Accordingly, the instructions 126 configure the processor 120 to perform one or more operations for forming the elections document 106 with the verification elements 108, as further described herein.

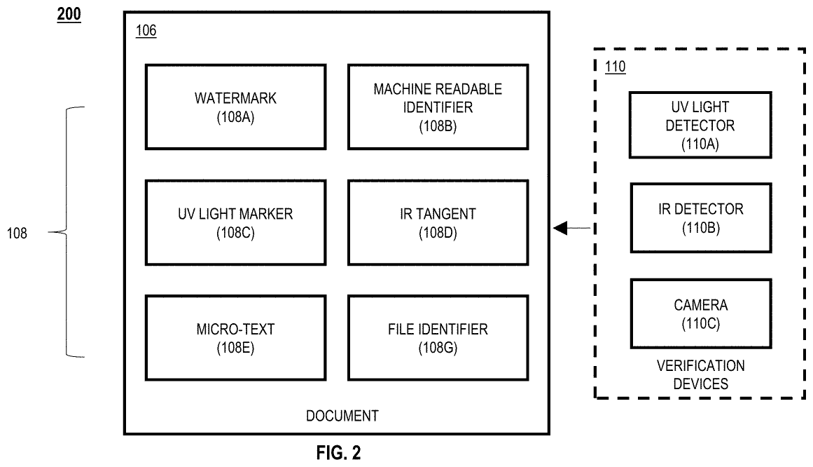

Referring to the general example 200 of the elections document 106 shown in FIG. 2 and with continuing reference to FIG. 1, the verification elements 108 of the elections document 106 are verifiable by one or more verification devices 110. By non-limiting examples, the verification devices 110 include a UV light detector 110A, an IR detector 110B, and a camera 110C. In some embodiments, the verification devices 110 may be discrete separate devices, or may be deployed within a single consolidated unit so that the elections document 106 can be verified as needed. Each of the verification devices 110 may be implemented in unique ways to verify or authenticate the elections document 106 downstream. For example, the elections document 106 may be formed with an IR tangent or feature (108D in FIG. 2) and the IR detector 110B can be implemented to read the IR tangent to, e.g., verify that the elections document 106 was actually formed from the paper manufacturing device 104A.

As shown in FIG. 2, the verification elements 108 of the elections document 106 may include by non-limiting examples, any number or combination of a watermark 108A, a machine-readable identifier 108B, a UV light marker 108C, an IR tangent 108D, micro-text 108E, and/or a file identifier 108F. The verification elements 108 or the elections document 106 generally may further include a UV “dead” feature where all fluorescents are removed during the paper manufacturing to remove all reflective properties on the surface of the paper used to form the elections document 106. In general, the UV light marker 108C, the IR tangent 108D, and the watermark 108A may be formed during the paper manufacturing process by the paper manufacturing device 104A or during the paper formation process generally. Other verification elements 108 such as the micro-text 108E, the machine-readable identifier 108B, and the unique file identifier 108F may be formed during the printing process by the printing device 104B or during the printing process generally.

Regarding the UV light marker 108C and the UV light detector 110A, the UV light marker 108C may include any number of unique UV patterns such as splatter or fibrous patterns, images, shapes, or configurations viewable by the UV light detector 110A when the UV light detector 110A emits UV light along the elections document 106. The UV light marker 108C may further include any text or information that appears visible to the human eye when the UV light detector 110A emits UV light along the elections document 106. In some embodiments, the UV light marker 108C is formed using ink comprising some fluorescent that illuminates when exposed to UV light, may be opaque, semi-opaque, and translucent, and may include acrylic monomers with a diluent and photoinitiator to participate in the curing reaction and respond to UV light. The UV light detector 110A may include any number of UV light emitting diodes (LEDs) that emit near UV light.

Regarding the watermark 108A, the subject verification element 108 can be implemented in a plurality of instances spaced at 7 inch intervals about the elections document 106, or in any other like arrangements. The watermark 108A may include a company name, elections jurisdiction, or any text or information. In some embodiments, the watermark 108A may comprise UV light features, such that the watermark 108A is only visible to the human eye using the UV light detector 110A as described.

Regarding the IR tangent 108D, the IR detector 1106 can be implemented to read the IR tangent 108D to, e.g., verify that the elections document 106 was actually formed from the paper manufacturing device 104A. The IR detector 1106 can include any thermal and/or photonic detector that reacts or reads IR radiation present within and/or along the elections document 106.

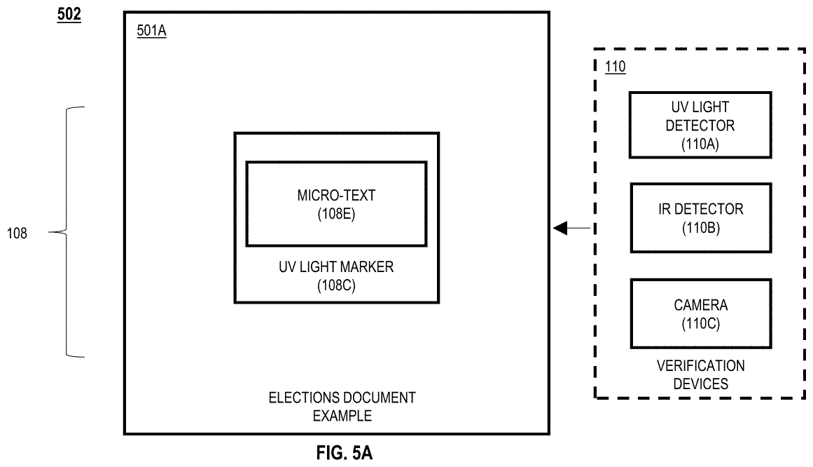

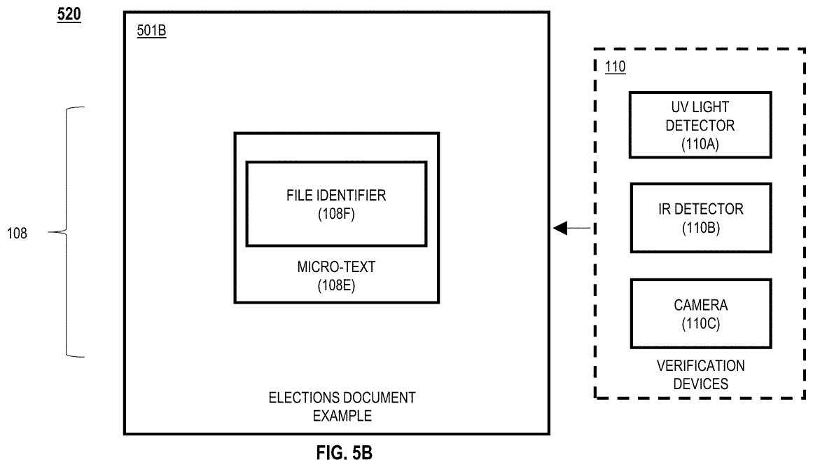

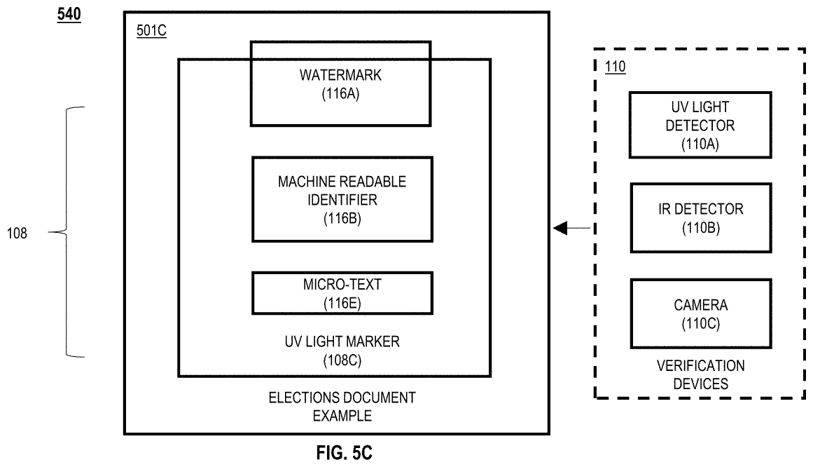

The camera 110C can be implemented to read the machine-readable identifier 108B, the micro-text 108E, and the file identifier 108F. The camera 110C may include any optical device capable of scanning and/or interpreting such content printed along the elections document 106. As described, any of the verification elements 108 may be combined in some form. So, for example, the micro-text 108E can include the file-identifier 108F in some embodiments corresponding to some data, external element, elections parameter, and the like that can be verified by identifying the subject verification elements 108 using the camera 110C or otherwise. The verification elements 108 may further be linked or correspond with one another; e.g., the machine-readable identifier 108B may be scanned by the camera 110C and identify the same text or information printed in the micro-text 108E. Any such combinations or variations of the verification elements 108 are contemplated (non-limiting examples shown in FIGS. 5A-5C).

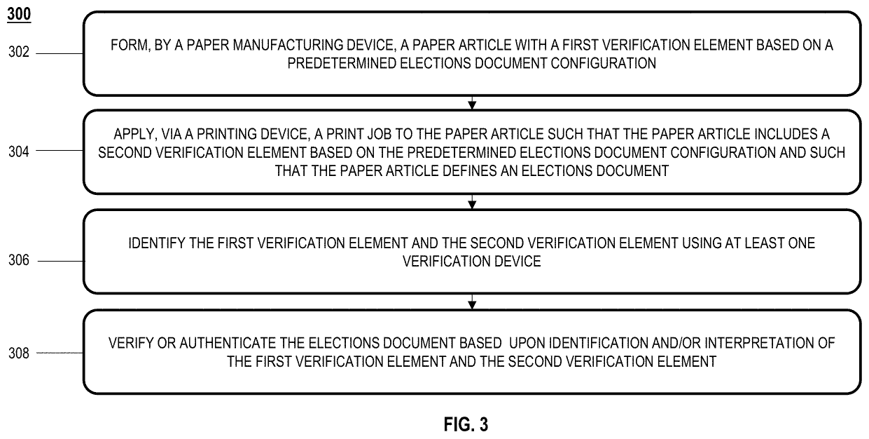

Referring to the process flow 300 of FIG. 3, exemplary steps associated with the system 100 are illustrated. As indicated in block 302, the paper manufacturing device 104A forms a paper article 101 with a first verification element based on a predetermined elections document configuration 112. In block 304, a printing device 1046 applies a print job to form a second verification element along the paper article 101 based on the predetermined elections document configuration 112. Examples of combinations of verification elements 108 are shown in FIGS. 5A-5C. In FIG. 5A,

In addition, referencing block 306 and block 308, the first verification element and the second verification element can be accessed, interpreted, or otherwise identified using one or more verification device 110 to verify an elections document 106 for elections processing.

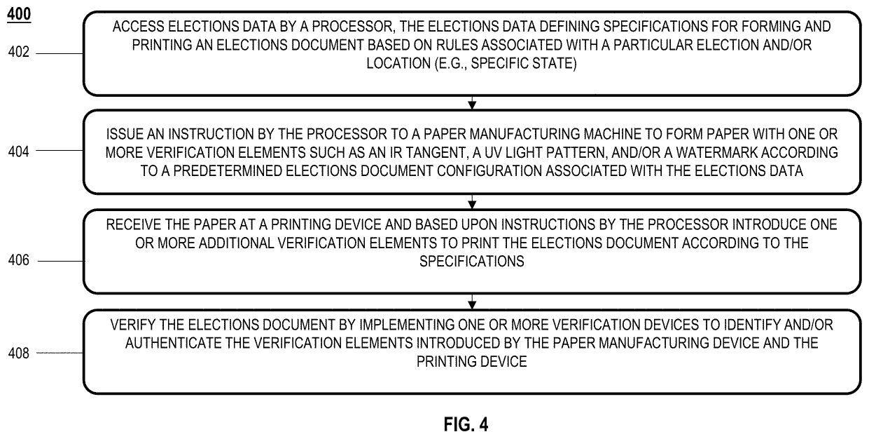

Referring to the process flow 400 of FIG. 4, exemplary steps associated with the system 100 are illustrated. In block 402, the processor 120 receives the elections data 124 from one or more of the devices 122. The elections data 124 includes any information defining specifications desired for generating the elections document 106, such as the desired configuration or type of verification elements 108 to be formed or implemented. In blocks 404 and 406, the elections document 106 is formed by manufacturing underlying paper with one or more of the verification elements 108, and optionally introducing other verification elements 108 during printing as described herein. As indicated in block 408, the verification devices 110 can then be implemented to identify, authenticate, and/or verify the verification elements 108 of the election document 106 as described.

Additional features and aspects of the system 100 are contemplated. For example, in some embodiments, the system 100 includes the integration of any functions related to petition processing, ballot sorters, ballot on demand hardware, electronic pollbooks, and ballot duplication. Further, in addition to more traditional voter registration and election management features, embodiments of the system 100 include core functional elements such as advanced election planning, personnel management, logistics management, ballot qualification, ballot and guides management, CRM capabilities, advanced geography capability, canvass integration and advanced election analytics.

In some embodiments, documents such as ballots generated by the system 100 via instructions provided by the processor 120 can be tailored to certain elections and/or precincts. For example, the elections document 106 may be made with a first number and combination of the verification elements 108 for a first voting precinct, and in other instances the elections document 106 may be made with a second number and combination of the verification elements 108 for a different voting precinct. In addition, the documents 106 may be tracked via a file identifier or any such identifier that designates a given jurisdiction or voting precinct.

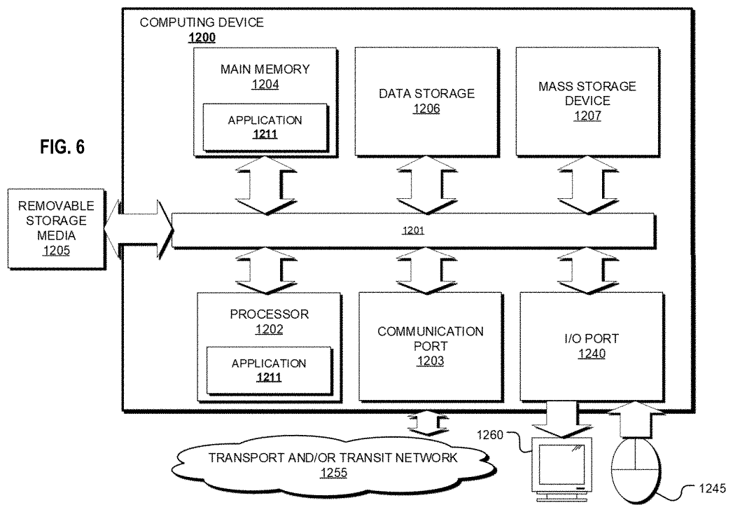

Referring to FIG. 6, a computing device 1200 is illustrated which may be configured, via one or more of an application 1211 or computer-executable instructions, to execute functionality described herein. More particularly, in some embodiments, aspects of the system 100 and/or the instructions 126 described herein may be translated to software or machine-level code, which may be installed to and/or executed by the computing device 1200 such that the computing device 1200 is configured to issue instructions or commands to generate and print the elections document 114 according to parameters and configurations associated with the data 108. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201, but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

It should be understood from the foregoing that, while particular embodiments have been illustrated and described, various modifications can be made thereto without depart from the spirit and scope of the invention as will be apparent to those skilled in the art. Such changes and modifications are within the scope and teachings of this invention as defined in the claims appended hereto.

What is claimed is:

1. A paper article enhanced for elections security and verification, comprising:
a paper body including a predetermined elections document configuration and defining an elections document; and
a plurality of verification elements forming the predetermined elections document configuration that verifies the elections document, the plurality of verification elements tailored to satisfy rules for verifying the elections document according to a predetermined elections process associated with the elections document,
wherein the plurality of verification elements is verifiable by one or more verification devices.

2. The paper article of claim 1, wherein the plurality of verification elements includes a micro-text identifier formed along a surface of the paper body.

3. The paper article of claim 2, wherein the plurality of verifications elements includes an infrared (IR) tangent formed within the paper body identifiable by an IR detector.

4. The paper article of claim 2, wherein the plurality of verifications elements includes an ultraviolet (UV) light marker formed along the paper body.

5. The paper article of claim 4, wherein the UV light marker is formed using ink comprising a fluorescent that illuminates when exposed to UV light.

6. The paper article of claim 4, wherein the UV light marker includes acrylic monomers with a diluent and photo initiator to participate in a curing reaction and respond to UV light.

7. The paper article of claim 1, wherein the plurality of verification elements includes an ultraviolet (UV) light marker, an infrared (IR) tangent, a watermark, a micro-text, and a machine-readable identifier.

8. The paper article of claim 1, wherein the one or more verification devices includes an ultraviolet (UV) light detector, an infrared (IR) detector, and a camera.

9. The paper article of claim 1, wherein the plurality of verification elements includes a unique combination of verification elements corresponding to rules of a given state such that verifying each of the plurality of verification elements authorizes the elections document as verified for elections processing in the given state.

10. The paper article of claim 1, wherein the plurality of verification elements includes:
a first verification element, and
a second verification element positioned over the first verification element.

11. The paper article of claim 1, wherein at least one of the plurality of verification elements includes an ultraviolet light marker formed to a predetermined shape configuration along a surface of the paper body.

12. The paper article of claim 1, wherein the plurality of verification elements includes:
an ultraviolet light marker formed along a surface of the paper body, and
a printed component formed along the surface of the paper body such that the printed component overlaps the ultraviolet light marker.

13. The paper article of claim 1, wherein the plurality of verification elements is selected from an ultraviolet (UV) light marker, an infrared (IR) tangent, a watermark, a micro-text, and a machine-readable identifier.

14. A method of manufacturing a paper article with enhanced security and verification for elections processing, comprising:
forming, by a paper manufacturing device, a paper article with a first verification element based on a predetermined elections document configuration; and
applying, via a printing device, a print job to the paper article such that the paper article includes a second verification element based on the predetermined elections document configuration,
wherein each of the first verification and the second verification element is verifiable by one or more verification devices.

15. The method of claim 14, further comprising:
accessing, via a processor, elections data defining rules associated with a state election; and
selecting the predetermined elections document configuration for manufacturing the paper article based upon the rules associated with the state election.

16. The method of claim 15, further comprising:
issuing an instruction from the processor to the paper manufacturing device to form the paper article with the first verification element based on the predetermined elections document configuration as selected; and
issuing an instruction from the processor to apply a print job to the paper article such that the paper article includes a second verification element based on the predetermined elections document configuration as selected.

17. The method of claim 16, further comprising:
issuing the instruction by the processor to the paper manufacturing device to form the paper article to be devoid of all fluorescents such that the paper article includes a UV dead feature.

18. A system for manufacturing paper articles as elections documents with enhanced verification and security measures, comprising:
a paper manufacturing device that forms a paper article defining an elections document with a first verification element; and
a printing device that receives the paper upon being formed from the paper manufacturing device and prints a second verification element along the paper article,
wherein each of the first verification and the second verification element is verifiable by one or more verification devices.

19. The system of claim 18, further comprising:
a processor in operable communication with the paper manufacturing device and the printing device, the processor operable to:
access elections data from one or more devices, the elections data including rules corresponding to an elections process,
instruct the paper manufacturing and the printing device to form the elections document first verification element and the second verification element, and
access an output from the one or more verification devices to verify the elections document.

20. The system of claim 18, wherein the one or more verification devices is selected from a group of an ultraviolet (UV) light detector, an infrared (IR) detector, and a camera.
